(19) United States
(12) Patent Application Publication
(10) Pub. No.: US 2014/0282239 A1
(43) Pub. Date: Sep. 18, 2014

(54) SELECTING A TOUCH SCREEN HOT SPOT

(71) Applicant: LENOVO (SINGAPORE) PTE, LTD., New Tech Park (SG)

(72) Inventors: Howard Locker, Cary, NC (US); John Weldon Nicholson, Cary, NC (US); Steven Richard Perrin, Raleigh, NC (US)

(73) Assignee: LENOVO (SINGAPORE) PTE, LTD., New Tech Park (SG)

(21) Appl. No.: 13/839,757

(22) Filed: Mar. 15, 2013

(51) Int. Cl. G06F 3/0482

(52) U.S. Cl. CPC G06F 3/0482
USPC 715/810; 715/764

(57) ABSTRACT

For selecting a touch screen hot spot, an indication module sequentially indicates each hot spot within a specified selection area about a projection of the selection object onto a touch screen. The sequential indication may be in response to the selection object hovering within a hover range of the touch screen. A selection module selects a hot spot in response to detecting movement of the selection object towards the touch screen concurrent with the indication of the selected hot spot.

### FIELD

The subject matter disclosed herein relates to selecting hot spots and more particularly relates to selecting touch screen hot spots.

### BACKGROUND

### Description of the Related Art

Touch screens are often used to provide a control interface for digital processing systems (DPS). The touch screens may be small in size and/or display small controls that are difficult to select.

### BRIEF SUMMARY

Based on the foregoing discussion, the inventors have recognized a need for an apparatus, method, and program product that select a touch screen hot spot. The apparatus includes a computer readable storage medium storing machine readable code and a processor executing the machine readable code. The machine readable code includes an indication module and selection module. The indication module sequentially indicates each hot spot within a specified selection area about a projection of the selection object onto a touch screen. The sequential indication may be in response to the selection object hovering within a hover range of the touch screen. The selection module selects a hot spot in response to detecting movement of the selection object towards the touch screen concurrent with the indication of the selected hot spot. The method and program product also perform the functions of the apparatus.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of the embodiments as set forth hereinafter.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a front view drawing illustrating one embodiment of a DPS 100;

FIG. 2 is a schematic diagram illustrating one embodiment of a selection object and touch screen;

FIG. 3 is a schematic diagram illustrating one embodiment of a selection object;

FIG. 4 is a schematic diagram illustrating one alternate embodiment of a selection object;

FIG. 5 is a front view drawing illustrating one embodiment of a DPS with a selection area;

FIGS. 6A-F are schematic diagrams illustrating embodiments of selection areas;

FIGS. 7A-H are schematic diagrams illustrating embodiments of sequential indication;

FIG. 8 is a schematic diagram illustrating one embodiment of a toward movement of the selection object;

FIG. 9 is a schematic diagram illustrating one embodiment of an away movement of the selection object;

FIG. 10 is a schematic block diagram illustrating one embodiment of a DPS;

FIG. 11 is a schematic block diagram illustrating one embodiment of a hot spot selection apparatus; and

FIG. 12 is a schematic flow chart diagram illustrating one embodiment of a selection method.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code. The storage devices may be tangible, non-transitory, and/or non-transmission.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in machine readable code and/or software for execution by various types of processors. An identified module of machine readable code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of machine readable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices, and may exist, at least partially, merely as electronic signals on a system or network. Where a module or portions of a module are implemented in software, the software portions are stored on one or more machine readable storage devices.

Any combination of one or more computer readable medium may be utilized. The computer readable medium may be a machine readable signal medium or a machine readable storage medium such as a computer readable storage medium. The machine readable storage medium may be a storage device storing the machine readable code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A machine readable signal medium may include a propagated data signal with machine readable code embodied therein, for example, in baseband or as part of a carrier wave. Such a propagated signal may take any of a variety of forms, including, but not limited to, electro-magnetic, optical, or any suitable combination thereof. A machine readable signal medium may be any storage device that is not a computer readable storage medium and that can communicate, propagate, or transport a program for use by or in connection with an instruction execution system, apparatus, or device. Machine readable code embodied on a storage device may be transmitted using any appropriate medium, including but not limited to wireless, wireline, optical fiber cable, Radio Frequency (RF), etc., or any suitable combination of the foregoing.

Machine readable code for carrying out operations for embodiments may be written in any combination of one or more programming languages, including an object oriented programming language such as Java, Smalltalk, C++ or the like and conventional procedural programming languages, such as the “C” programming language or similar programming languages. The machine readable code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by machine readable code. These machine readable code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The machine readable code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The machine readable code may also be loaded onto a computer, other programmable data processing apparatus, or other devices to cause a series of operational steps to be performed on the computer, other programmable apparatus or other devices to produce a computer implemented process such that the program code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and machine readable code.

Descriptions of figures may refer to elements described in previous figures, like numbers referring to like elements.

FIG. 1 is a front view drawing illustrating one embodiment of a DPS 100. The DPS 100 includes a touch screen 110. The touch screen 110 may employ technologies that include but are not limited to resistive, acoustic wave, surface capacitance, projected capacitance, mutual capacitance, self capacitance, infrared, optical imaging, acrylic projection, signal dispersion, and acoustic pulse.

The touch screen 110 may display data such as text, images, video, and hot spots 105. The activation of a hot spot 105 may initiate an application, a function, or the like. A hot spot 105 may be activated when selected with a selection object. Hot spots 105 may be icons, controls, and the like.

Unfortunately, when the touch screen 110 is small relative to the selection object, and/or when hot spots 105 are small relative to the selection object, it may be difficult for a user to accurately select a desired hot spot 105. The embodiments described herein support the accurate selection of hot spots 105 by sequentially indicating each hot spot 105 within a selection area when the selection object hovers near the touch screen 110, allowing the accurate selection of an indicated hot spot 105 as will be described hereafter.

FIG. 2 is a schematic diagram illustrating one embodiment of a selection object 205 and touch screen 110. The selection object 205 may be a finger, a knuckle, other portions of the body, a stylus, and the like.

The touch screen 110 may detect the selection object 205 within a hover range 210. In one embodiment, the touch screen 110 detects a distance 216 between a closest portion 240 of a selection object area of the selection object 205 and the touch screen 110. In one embodiment, the selection object 205 is detected by a changing the resistance of the touch screen 110 in response to the proximity of the selection object 205. Alternatively, the selection object 205 may be detected by a change in the capacitance of the touch screen 110 in response to the proximity of the selection object 205. In one embodiment, the selection object 205 is detected by the selection object 205 interrupting an acoustic wave. Alternatively, the selection object 205 may be detected by interrupting an optical wave such as an infrared wave, the visible spectrum wave, and ultraviolet wave, or the like. In one embodiment, the selection object 205 is detected by a change in a piezoelectric charge in the touch screen 110.

The hover range 110 may begin at a contact distance 215. The touch screen 110 may detect a contact of the selection object 205 if the selection object 205 is within the contact distance 215 of the touch screen 110. In one embodiment, the contact distance 215 is in the range of 0 to 5 millimeters (mm). The hover range 110 may be between 0.2 and 1.5 centimeters (cm). Alternatively the hover range 110 may be between 0.1 and 7.5 cm.

FIG. 3 is a schematic diagram illustrating one embodiment of the selection object 205. The touch screen 110 may determine the distance 216 between the selection object 205 and the touch screen 110 from the selection object area 220. The touch screen 110 may determine a selection object area 220. In the depicted embodiment, the selection object area 220 is determined to be in a closest portion 240 of the selection object 205. In one embodiment, the selection object area 220 is determined to be in a center area of the closest portion 240 of the selection object 205. For example, the selection object area 220 may be determined at a center of the fingertip or a center of a stylus.

FIG. 4 is a schematic diagram illustrating one alternate embodiment of a selection object 205. In the depicted embodiment, the selection object area 220 is determined to be on an upper edge of the selection object 205. Alternatively, the selection object area 220 may be an area located on the lower edge of the selection object 205, on the right edge of the selection object 205, and on the left edge of the selection object 205. The edge of the selection object 205 may a portion of the selection object 205 that is closest to the touch screen 110. For example, the selection object area 220 may be located on an edge of the fingertip, an edge of a stylus, or the like. In addition, the selection object area 220 may extend beyond the selection object 205.

FIG. 5 is a front view drawing illustrating one embodiment of a DPS 100 with a selection area 245. In response to detecting the selection object 205 hovering within the hover range 210 of the touch screen 110, the touch screen 110 may determine a projection 225 on the touch screen 110. The projection 225 may be on a vector normal to a plane of the touch screen 110 that intersects the selection object area 220.

A selection area 245 of the touch screen 110 may be determined relative to the projection 225. In the depicted embodiment, the selection area 245 is the area within a circle centered on the projection 225. The circle may have a target radius from the projection 225. However, the selection area 245 may be an area of any shape and may be disposed in any direction and at any distance from the projection 225. For example, the selection area 245 may be asymmetrically biased from the projection 225.

A hot spot 105 may be considered within the selection area 245 if the hot spot is completely within the selection area 245. Alternatively, the hot spot 105 may be considered within the selection area 245 if any portion of the hot spot 105 is within this selection area 245. In one embodiment, the hot spot 105 is considered within the selection area 245 if the center of the hot spot 105 is within the selection area 245. In a certain embodiment, the hot spot 105 is considered within the selection area 245 is most of an area of the hot spot 105 is within the selection area 245.

In one embodiment, the selection area 245 may be user-defined. For example, a user may set one or more parameters including a shape of the selected area 245, a size of the selected area 245, a direction of the selected area 245 from the projection 225, and a distance of the selected area 245 from the projection 225.

FIGS. 6A-F are schematic diagrams illustrating embodiments of selection areas 245. In FIGS. 6A-F, the DPS 100 and whole of the touch screen 110 are not shown for simplicity. In FIG. 6A, the selection area 245 is depicted as an ellipse centered on the projection 225. Alternatively, a center of the selection area 245 may be offset from the projection 225.

FIG. 6B depicts the selection area 245 as an octagon centered on the projection 225. Alternatively, the center of the selection area 245 may be offset from the projection 225. FIG. 6C depicts the selection area 245 as a square, with the square offset from the projection 225. Alternatively, the selection area 245 may be centered on the projection 225.

FIG. 6D depicts the selection area 245 as a rectangle, with a rectangle offset from the projection 225. Alternatively, the selection area 245 may be centered on the projection 225. FIG. 6E depicts the selection area 245 as a triangle, with the triangle offset from the projection 225. Alternatively, the selection area 245 may be centered on the projection 225.

FIG. 6F depicts the selection area 245 as an ellipse, with the center of the ellipse offset from the projection 225. Alternatively, the selection area 245 may be centered on the projection 225. One of skill in the art will recognize that the embodiments may be practiced with any or all of the shapes depicted in FIGS. 10-15, other shapes, and various orientations of the shapes to the projection 225.

FIGS. 7A-H are schematic diagrams illustrating one embodiment of sequential indication 250. The hot spots 105 of FIG. 1 are shown. For simplicity, the DPS 100 and the touch screen 110 are not shown.

In response to the selection object 205 hovering within the hover range 210 of the touch screen 110, each of the hot spots 105 within the selection area 245 is sequentially indicated. In FIG. 7A, a first hot spot 105a is indicated. A hot spot 105 may be indicated by highlighting the hot spot 105. For example, the hot spot 105 may be displayed with increased brightness. Alternatively, the hot spot 105 may be displayed with increased contrast, or increasing transparency, or blinking. In one embodiment, the indicated hot spot 105 is displayed with normal brightness while all other objects and hot spots 105 on the touch screen 110 are displayed with diminished brightness, or any visual indicator that is visible to the user

In FIG. 7B, a second hot spot 105b is indicated after the first hot spot 105a is indicated. Similarly, in FIG. 7C, a third hot spot 105c is indicated after the second hot spot 105b is indicated. In FIG. 7D, fourth hot spot 105d is indicated after the third hot spot 105c is indicated.

In FIGS. 7A-D, hot spots 105 are indicated in a left to right, top to bottom sequence. Alternatively, the hot spots 105 may be indicated in a right to left, top to bottom sequence. In one embodiment, the hot spots 105 are indicated in a bottom to top, left to right sequence. In an alternate embodiment, the hot spots 105 are indicated in a bottom to top, right to left sequence.

In addition, hot spots 105 may be indicated in random order. In a certain embodiment, the hot spots 105 are indicated in an alphanumeric order. In one embodiment, the hot spots 105 are indicated in order of each hot spots' proximity to the projection 225. The proximity of a hot spot 105 to the projection 225 may be measured from an edge of the hot spot 105 nearest to the proximity point 225 to the proximity point 225. Alternatively, the proximity of a hot spot 105 may be measured from a center of the hot spot 105 to the proximity point 225. Thus a hot spot 105 that a user was likely attempting to select with the selection object 205 may be indicated first. In one embodiment, the proximity of the hot spot 105 is measured from a location on the touch screen 110 such as a combination of horizontal and vertical distances, vertical and horizontal distances, or the like.

In one embodiment, the hot spots 105 are indicated in order based on the historical frequency of selection. Each selection of a hot spot 105 may be recorded. In one embodiment, each selection of the hot spot 105 is recorded with a timestamp. In one embodiment, a hot spot 105 that was historically selected most frequently is indicated first, followed by a hot spot 105 that was historically selected next most frequently. In one embodiment, a historical selection score HS is calculated for each hot spot 105 using Equation 1, where s is each historical selection of the hot spot 105.

HS=Σs Equation 1

Alternatively, the historical selection score HS may be calculated using Equation 2, where Δt is a time interval to the historical selection s.

HS=Σs/Δt Equation 2

In one embodiment, the hot spots 105 are indicated in order from the hot spot 105 with the highest historical selection score to the hot spot 105 with the lowest historical score.

FIGS. 7E-H depict an alternate embodiment of indicating a hot spot 105. The first hot spot 105a is indicated by enlarging the first hot spot 105a. FIG. 7F depicts the second hot spot 105b as indicated after the indication of the first hot spot 105a by enlarging the second hot spot 105b. Similarly, subsequent to the indication of the second hot spot 105b, the fourth hot spot 105d is indicated by enlarging the fourth hot spot 105d. Subsequent to the indication of the fourth hot spot 105d, the third hot spot 105c is indicated by enlarging the third hot spot 105c. Thus the hot spots 105 are indicated in the clockwise order. Alternatively, the hot spots 105 may be indicated in a counterclockwise order.

FIG. 8 is a schematic diagram illustrating one embodiment of a toward movement 264 of the selection object 205. The selection object 205 is depicted as moving toward 264 the touch screen 110

FIG. 9 is a schematic diagram illustrating one embodiment of an away movement 268 of the selection object 205. The selection object 205 is depicted as moving away 268 from the touch screen 110.

FIG. 10 is a schematic block diagram illustrating one embodiment of the DPS 100. The DPS 100 may include a processor 305, a memory 310, and communication hardware 315. The memory 310 may be a computer readable storage medium such as a semiconductor storage device, a hard disk drive, an optical storage device, a holographic storage device, a micromechanical storage device, or the combinations thereof. The memory 310 may store machine readable code. The processor 305 may execute the machine readable code. The communication hardware 315 may communicate with the touch screen 110 and other devices.

FIG. 11 is a schematic block diagram illustrating one embodiment of a hot spot selection apparatus 400. The apparatus 400 may be embodied in the DPS 100. The apparatus 400 includes an indication module 405 and a selection module 410. In one embodiment, the indication module 405 and the selection module 410 are in communication with the touch screen 110. In an alternate embodiment, the indication module 405 and/or the selection module 410 include the touch screen 110.

The indication module 405 and the selection module 410 may be embodied in a computer readable storage medium such as the memory 310. The computer readable storage medium may store machine readable code that is executed by the processor 305 to perform the functions of the apparatus 400. Alternatively, the indication module 405 and the selection module 410 may be embodied in one or more semiconductor circuits. The semiconductor circuits may be in the touch screen 110. Alternatively, the semiconductor circuits may be separate from and in communication with the touch screen 110. In a certain embodiment, the indication module 405 and the selection module 410 are embodied in a combination of machine readable code stored in a computer readable storage medium and semiconductor circuits.

The indication module 405 sequentially indicates each hot spot 105 within the specified selection area 245 about a projection 225 of the selection object 205 onto the touch screen 110. The indication module may sequentially indicate each hot spot 105 in response to the selection object 205 hovering within the hover range 210 of the touch screen 110.

The selection module 410 may select a hot spot 105 in response to detecting a movement of the selection object 205 towards 264 the touch screen 110 concurrent with the indication of the selected hot spot 105. Thus if the selection object 205 moves toward 264 the touch screen 110 subsequent to hovering within the hover range 110, the selection module 410 selects the hot spot 105 that is indicated during the movement toward 264 the touch screen 110.

FIG. 12 is a schematic flow chart diagram illustrating one embodiment of a selection method 500. The method 500 may perform functions of the apparatus 400 and the DPS 100. In one embodiment, the method 500 is performed by semiconductor gates. Alternatively, the method 500 may be performed by a processor 305. In one embodiment, the method is performed by a program product comprising a computer readable storage medium such as the memory 310. The computer readable storage medium may store machine readable code that is executed to perform the functions of the method 500. In a certain embodiment, the method 500 is performed by a combination of semiconductor gates and a computer readable storage medium.

The method 500 starts, and in one embodiment, the indication module 405 detects 502 the selection object 205 hovering within the hover range 210. The selection object 205 may be determined to be hovering within the hover range 210 if the selection object 205 remains within the hover range 210 for a specified hover interval. The hover interval may be in the range of 500 to 2000 milliseconds. Alternatively, the selection object 205 is determined to be hovering within the hover range 210 if movement towards 264 the touch screen 110 and/or movement away 268 from the touch screen 110 is less than a movement threshold. The movement threshold may be in the range of 1 to 5 mm. In a certain embodiment, the selection object 205 is determined to be hovering within the hover range 210 if the movement towards 264 the touch screen 110 and/or the movement away 258 from the touch screen 110 is less than the movement threshold for the hover interval.

The indication module 405 may further identify 504 each hot spot 105 within the specified selection area 245. In one embodiment, each hot spot 105 that is completely within the selection area 245 is identified 504. Alternatively, each hot spot 105 with a portion of the hot spot 105 within the selection area 245 may be identified 504. In one embodiment, each hot spot 105 with a hot spot center within the selection area 245 is identified 504. In a certain embodiment, each hot spot 105 with at least half of the hot spot's area within the selection area 245 is identified 504.

The indication module 405 may sequentially indicate 506 each hot spot 105 within the specified selection area 245. The indication module 405 may sequentially indicate 506 each hot spot 105 within the specified selection area 245 in response to the selection object 205 hovering within the hover range 210 of the touch screen 110.

The hot spots 105 may be sequentially indicated 506 in a specified order. The specified order may include but is not limited to a horizontal/vertical order, a circular order, an order based on the historical selection score, an order based on proximity to the projection 225, a random order, a user-defined order, and the like. Hot spots 105 may be indicated by increasing a brightness of the hot spot 105, increasing a contrast of the hot spot 105, decreasing a brightness of all other objects on the touch screen 110 except for the indicated hot spot 105, enlarging the indicated hot spot 105, diminishing the size of all other hot spots 105 within the selection area 245 except for the indicated hot spot 105, and the like.

In one embodiment, the hot spot 105 is indicated 506 for an indication interval. The indication interval may be in the range of 500 to 2000 milliseconds. The indication interval may be set with a control panel.

The selection module 410 may determine 508 if there is a movement toward 264 the touch screen 110. If there is no movement toward 264 the touch screen 110, the indication module 405 continues to sequentially indicate 506 each hot spot 105.

If there is movement toward 264 the touch screen 110, the selection module 410 pauses 510 the sequential indication 506 of the hot spots 105. For example, if the third hot spot 105c is indicated by increased brightness, the third hot spot 105c will continue to be indicated with increased brightness after the indication interval has expired.

The selection module 410 may further determine 512 if there is movement relative to the touch screen 110. If there is a movement away 268 from the touch screen 110, the indication module 405 resumes sequentially indicating 506 each hot spot 105.

If there is no movement relative to the touch screen 110, the selection module 410 continues to pause 510 the sequential indication of the hot spots 105. If there is movement toward 264 the touch screen, the selection module 410 selects the hot spot 105 that is currently indicated. For example, if the third hot spot 105c is currently indicated concurrent with detecting movement of the selection object 205 towards 264 the touch screen 110, the selection module 410 selects 514 the third hot spot 105c as the selected hot spot 105.

In one embodiment, the selection module 410 activates 516 the selected hot spot 105 and the method 500 ends. The selected hot spot 105 may be activated 516 by launching an application associated with the selected hot spot 105. Alternatively, the selected hot spot 105 is activated 516 by initiating a function associated with the selected hot spot 105. In one embodiment, activating 516 the selected hot spot 105 comprises displaying a menu for the selected hot spot 105. The menu may comprise one or more options for further activating the selected hot spot 105.

In one embodiment, the options of the menu may be sequentially indicated in response to the selection object 205 hovering within the hover range 210 of the touch screen 110. In addition, a currently indicated option of the menu may be selected in response to detecting movement of the selection object 205 towards the touch screen 110 concurrent with the indication of the selected option.

By sequentially indicating the hot spots 105 in response to the selection object 205 hovering within the hover range 210 of the touch screen 110, the embodiments allow the accurate selection of a hot spot 105 by detecting a movement of the selection object 205 towards 264 the touch screen 110 concurrent with the indication of the selected hot spot 105. Thus a desired hot spot 105 may be accurately selected even with a selection object 205 that is relatively large compared with the hot spots 105 on the touch screen 110.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a memory storing machine readable code;
a processor executing the machine readable code, the machine readable code comprising:
an indication module sequentially indicating each hot spot within a specified selection area about a projection of a selection object onto a touch screen in response to the selection object hovering within a hover range of the touch screen; and
a selection module selecting a hot spot in response to detecting movement of the selection object towards the touch screen concurrent with the indication of the selected hot spot.

2. The apparatus of claim 1, the selection module further pausing the sequential indicating of each hot spot in response to a movement of the selection object towards the surface of the touch screen.

3. The apparatus of claim 2, the selection module further resuming the sequential indicating of each selectable hot spot in response to a movement of the selection object away from the surface of the touch screen.

4. The apparatus of claim 1, wherein the projection is on a vector normal to the touch screen and intersecting a selection object area.

5. The apparatus of claim 1, wherein:
the indication module detects the selection object hovering within the hover range of the touch screen and identifies each hot spot within the specified selection area; and
the selection module activates the selected hot spot.

6. The apparatus of claim 5, wherein activating the selected hot spot comprises displaying a menu for the selected hot spot.

7. A method comprising:
sequentially indicating, by use of a processor, each hot spot within a specified selection area about a projection of a selection object onto a touch screen in response to the selection object hovering within a hover range of the touch screen; and
selecting, by use of a processor, a hot spot in response to detecting movement of the selection object towards the touch screen concurrent with the indication of the selected hot spot.

8. The method of claim 7, wherein the selection object is selected from the group consisting of a finger, a glove, and a stylus.

9. The method of claim 7, further comprising pausing the sequential indicating of each hot spot in response to a movement of the selection object towards the surface of the touch screen.

10. The method of claim 9, further comprising resuming the sequential indicating of each selectable hot spot in response to a movement of the selection object away from the surface of the touch screen.

11. The method of claim 7, wherein the selection area is asymmetrically disposed from the projection.

12. The method of claim 7, wherein the projection is on a vector normal to the touch screen and intersecting a selection object area.

13. The method of claim 7, further comprising:
detecting the selection object hovering within the hover range of the touch screen;
identifying each hot spot within the specified selection area; and
activating the selected hot spot.

14. The method of claim 13, wherein activating the selected hot spot comprises displaying a menu for the selected hot spot.

15. A program product comprising a computer readable storage medium storing machine readable code executable by a processor to perform the operations of:
sequentially indicating, by use of a processor, each hot spot within a specified selection area about a projection of a selection object onto a touch screen in response to the selection object hovering within a hover range of the touch screen; and
selecting, by use of a processor, a hot spot in response to detecting movement of the selection object towards the touch screen concurrent with the indication of the selected hot spot.

16. The program product of claim 15, further comprising pausing the sequential indicating of each selectable hot spot in response to a movement of the selection object towards the surface of the touch screen.

17. The program product of claim 16, further comprising resuming the sequential indicating of each selectable hot spot in response to a movement of the selection object away from the surface of the touch screen.

18. The program product of claim 15, wherein the selection area is asymmetrically disposed from the projection.

19. The program product of claim 18, wherein the projection is on a vector normal to the touch screen and intersecting a selection object area.

20. The program product of claim 15, further comprising:
detecting the selection object hovering within the hover range of the touch screen;
identifying each hot spot within the specified selection area; and
activating the selected hot spot.
